(19) United States
(12) Patent Application Publication
(10) Pub. No.: US 2011/0023998 A1
(43) Pub. Date: Feb. 3, 2011

(54) Wood Splitting Wedge

(76) Inventors: Patvakan Hakhinyan, Yerevan (AM); Karen Gasparyan, Yerevan (AM)

Correspondence Address: Paytsar Saribekyan, 28 Khorenatsee St, Yerevan, 0018, omitted

(21) Appl. No.: 12/442,708

(22) PCT Filed: Sep. 7, 2007
(86) PCT No.: PCT/AM07/00003

§ 371 Date: Nov. 27, 2009

(30) Foreign Application Priority Data
Sep. 25, 2006 (AM) AM20060163

(51) Int. Cl. B27L 7/06

(52) U.S. Cl. 144/195.7; 254/104

(57) ABSTRACT

A wood splitting wedge having high level of splitting capacity and durability and capable of splitting a log into four pieces at once. The wood splitting wedge is comprised of main twice-inclined splitting ribs (3) compatible with the sides of upper and lower regular tetrahedral pyramids and complemented by supplementary pushing ribs (7) compatible with the ribs of supplementary regular tetrahedral pyramid having smaller section and revolved at 45° relative to upper and lower pyramids.

### BACKGROUND OF THE INVENTION

1. Field of the Invention

The present invention relates to a cutting device, and more particularly to a wood splitting device having main twice-inclined splitting ribs compatible with the ribs of main upper and lower regular tetrahedral pyramids and complemented by supplementary pushing ribs compatible with the ribs of supplementary regular tetrahedral pyramid with the lesser section and revolved at 45° with respect to the main pyramids, that advances the splitting capacity and durability of the wedge and simultaneously enables the user to split a log into four.

2. Description of the Prior Art

The use of wedges to split a log is known in the prior art.

The patents FR0182174 A1, FR2666270, FR2862903, U.S. Pat. No. 1,813,033 A3 and U.S. Pat. No. 4,387,753, all of B27 L 7/00 and B26 B23/00 class, disclose wedges having limited capacity as they split a log into two pieces, and even more, the wedge can go backward during splitting and jump out from the log.

The present invention is close to known wedge presented by U.S. Pat. No. 1,813,033 A3, which has a head constructed as one piece with a tetrahedral pyramid pointed wedge having its splitting ribs compatible with the ribs of a regular tetrahedral pyramid, and four lateral triangle-shaped sides that are either smooth or concave.

The known wedge, given its capacity to split a log into four in two counter-perpendicular directions, also has the following disadvantages:
Throughout the height of the wedge, the ribs splitting a log have the same inclination with respect to the axis of the wedge.
An anti-rebound feature of the wedge during splitting.

The present invention is close to known pyramidal wedge presented by U.S. Pat. No. 4,387,753 dated June 1983, which is comprised of two splitting ribs and two short ribs. The two short ribs are symmetrically positioned on the plane designed by the two splitting ribs at the pointed section of the wedge and are inclined at small angle with respect to the axis of the wedge. In the midst of the wedge, said two short ribs are combined with two rectangular pushing sides inclined at greater angle with respect to the axis of the wedge at its upper end extremity.

The latter promote splitting using two splitting ribs and pushing pieces and getting them separated from each other, and simultaneously releasing the pointed end of the wedge and diminishing its friction.

The known wedge split a log only into two pieces and has low productivity as each of two splitting ribs is straight-line and has the same inclination with respect to the axis of the wedge at all sides.

In accordance with the present invention, a wood splitting wedge differs from known wedges in high level of splitting capacity, splitting safety and productivity.

### SUMMARY OF THE INVENTION

Comparing with known splitting wedges, the present invention presents a new design of a wedge that, given its advantages and capacities along with contemporary wedges, allows the user to split a log into four at once, simultaneously increasing safety, solidity, and durability of the wedge.

It is an object of the present invention to effectively split a log into four in two counter-perpendicular directions.

It is another object of the present invention to advance the splitting feature of the wedge.

It is a further object of the present invention to increase safety of wood splitting and durability of the wedge through advancing its firmness.

Along with advantages which characterize known wood wedges such as:
Splitting of a log using striking forces and
Exclusion of anti-rebound feature of the wedge when splitting a log,
   the wedge, according to the present invention, has some other advantages provided hereinbelow:
greater firmness and, therefore, higher durability,
safe and effective splitting of a log into four and
higher level of splitting.

### BRIEF DESCRIPTION OF THE DRAWINGS

In accordance with the present invention, structure and the essence of a wood splitting wedge will now be described with reference to the annexed drawings wherein:

FIG. 1 is a general view of a wood splitting wedge;

FIG. 2 is an A-A section of a wedge at a quarter height from its pointed end;

FIG. 3 is a B-B section of a wedge at the middle of its height;

FIG. 4 is a C-C section of a wedge at a three-forth height from its pointed end;

FIG. 5 are upper and lower main regular tetrahedral pyramids having its ribs compatible with the twice-inclined splitting ribs (that have diverse inclinations at upper and lower end extremities of the wedge) of the wedge and supplementary regular tetrahedral pyramid having its ribs compatible with the pushing ribs of the wedge.

### DESCRIPTION OF THE PREFERRED EMBODIMENT

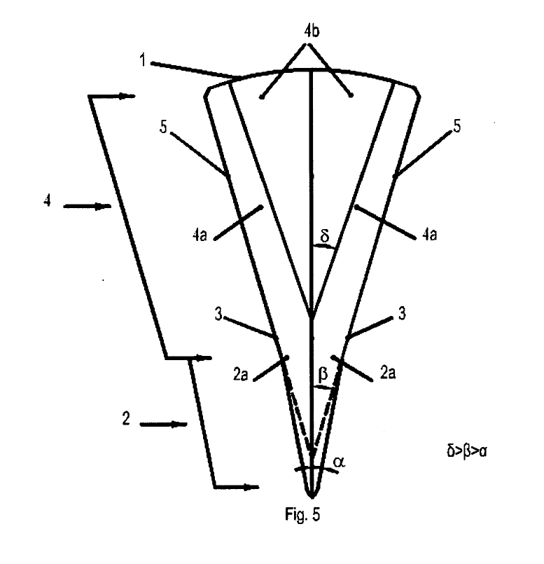

A wood splitting wedge comprises a convex head 1 adapted to receive a striking force from the hammer, pointed lower end extremity 2 having its lower portions 3 of ribs splitting a log coincided with the ribs of the lower main regular tetrahedral 2a pyramid (FIG. 5) that allow startup cleavage of the log to be split, and upper end extremity 4 having its upper portions 5 of the ribs splitting a log coincided with the ribs of the upper main regular tetrahedral 4a truncated pyramid (FIG. 5) that allow final splitting of the log.

Each of the upper portions 5 of the ribs splitting a log is provided with four identical notches 6 that exclude an anti-rebound feature of the wedge.

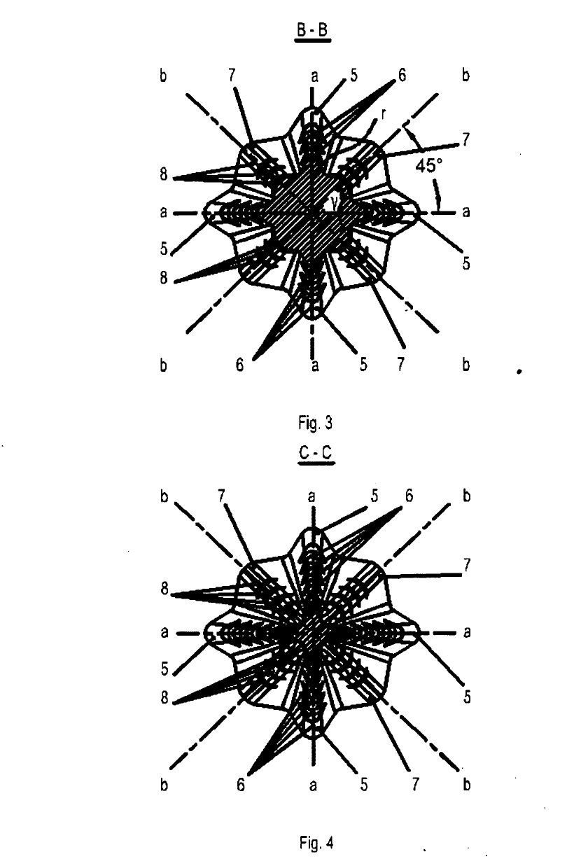

On the planes perpendicular to the axis of the wedge, each splitting rib 3 of the wedge has a section in the shape of an isosceles triangle having its pointed apex conjugated with a round arc at an r radius (FIGS. 3 and 4) so that the section comprising splitting ribs at the lower end extremity of the wedge presents four-edged star having sharp filleted triangle-shaped fingers as shown in FIG. 2. This considerably increases firmness and solidity of the wedge and, therefore, its durability.

An angle γ of the apex of the isosceles triangle-shaped section of each splitting rib of the wedge is constant at all sections throughout the height of the wedge. The value of an angle falls within γ=30° . . . 80°. In contrast to the angle γ, the r radius of the said conjugated pointed apexes of the isosceles triangle-shaped sections increases linearly from bottom to top throughout the height of the wedge and ranges from 0.5 mm to 10 mm.

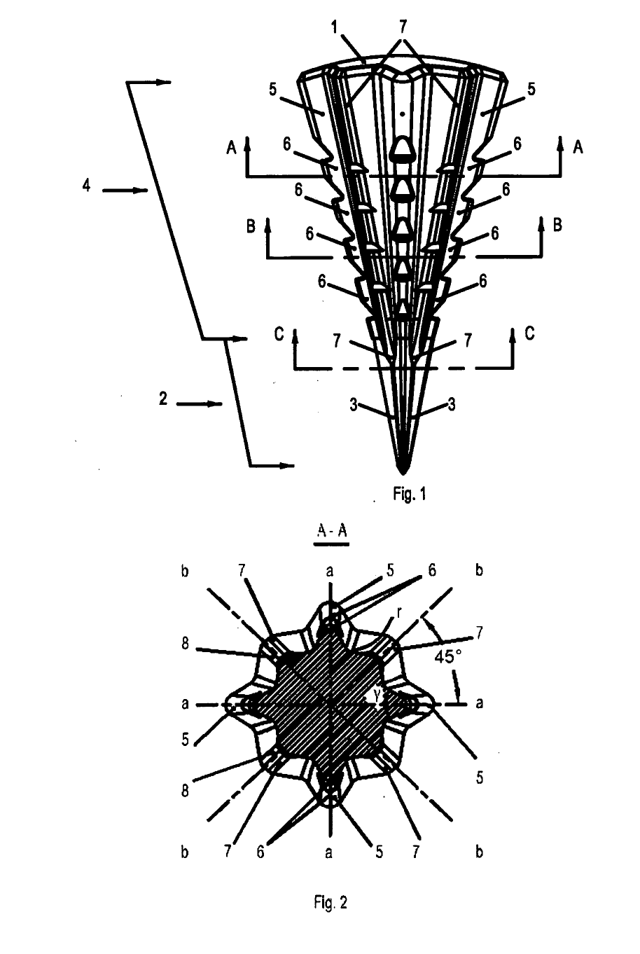

At its upper end extremity 4, the wood splitting wedge is also provided with pushing ribs 7 compatible with the ribs of a supplementary regular tetrahedral pyramid 4b and having four identical notches 8 (FIGS. 1 and 5). In the sections perpendicular to the axis of the wedge, each of pushing ribs is designed as an isosceles trapezium having its slanting ribs shaped as round arcs with two diverse radii and compatible with the ribs of the supplementary regular tetrahedral pyramid wherein inclination δ=β+(3° . . . 5°) is greater with respect to the axis of the wedge than inclination β of the splitting ribs of the upper portions of the wedge as shown in FIG. 5.

In FIGS. 3 and 4, the sections B-B and C-C of the upper end extremity 4 of the wood splitting wedge show that pushing ribs 7 compatible with the ribs of a supplementary tetrahedral pyramid are closely positioned to the axis of the wedge.

Unlike the main splitting ribs 5 (leading ribs) that split a log in the line of a-a, the pushing ribs 7 of the wedge promote splitting through pushing the segments of a log to be split by b-b planes positioned within a-a splitting adjacent planes (FIGS. 2, 3, and 4).

To split a log, the wedge with its pointed end 2 penetrates into the midst of a log and the splitting ribs 3 get a log split through a-a planes. During follow-on penetration, final splitting of the log into four occurs by means of the splitting ribs 5 of the upper end extremity 4.

What is claimed is:

1. A wood splitting wedge designed as one piece, comprising a head adapted to receive a striking force, a pyramidal pointed lower end extremity having lower portions of ribs splitting a log that form a small angle a with the axis of the wedge, and upper end extremity having sides pushing split log and upper portions symmetrical to said sides forming the continuations of the lower portions of the splitting ribs of the wedge and having an angle β with respect to the axis of the wedge being larger than said angle α so that each of the ribs splitting a log is designed twice-inclined and positioned on the same with the axis of the wedge plane.

2. A wood splitting wedge according to claim 1, wherein said head adapted to receive a striking force is designed as a convex spherical surface having its center compatible with the pointed end of the lower end extremity of the wedge.

3. A wood splitting wedge according to claims 1 and 2, wherein upper portions of splitting twice-inclined ribs coincide with the ribs of the upper main regular tetrahedral truncated pyramid having the same with the wedge axis, and lower portions of said splitting twice-inclined ribs coincide with the ribs of the lower main regular tetrahedral pyramid having the same with the wedge axis.

4. A wood splitting wedge according to claims 1-3, wherein at the planes perpendicular to the axis of the wedge, each splitting rib has a section in the shape of an isosceles triangle having its pointed apex conjugated with a round arc and its apex with an γ angle less than 90° so that the section comprising lower portions of splitting ribs of the wedge presents four-edged star having sharp filleted triangle-shaped fingers.

5. A wood splitting wedge according to claim 4, wherein the radius of rounded conjugated segments of said apexes of the triangle-shaped sections of the splitting ribs increases linearly from bottom to top throughout the height of the wedge and ranges from 0.5 mm to 10 mm.

6. A wood splitting wedge according to claim 5, wherein an angle γ of the apexes of the triangle-shaped sections of splitting ribs falls within 30° . . . 80°.

7. A wood splitting wedge according to claims 3 and 4, wherein upper portions of the twice-inclined splitting ribs are provided with notches excluding a possible anti-rebound feature of the wedge when splitting a log.

8. A wood splitting wedge according to claim 7, wherein sides pushing split log are designed as pushing ribs so that in the sections perpendicular to the axis of the wedge, each of said pushing ribs is designed as an isosceles trapezium having each of its slanting ribs shaped as round arcs with two diverse radii.

9. A wood splitting wedge according to claim 8, wherein ribs pushing a split log are positioned along the ribs of the supplementary regular tetrahedral pyramid revolved at 45° with respect to upper main regular tetrahedral truncated pyramid.

10. A wood splitting wedge according to claim 9, wherein ribs pushing a split log are provided with notches excluding a possible anti-rebound feature of the wedge when splitting a log.

11. A wood splitting wedge according to claims 1-8, wherein the main and supplementary pyramids, positioned at said upper end extremity of the wedge and revolved at 45° with respect to each other, are designed in a way that at any height the diameters of the section of the supplementary regular tetrahedral pyramid are lesser than the diameters of the section of the main truncated pyramid so that said pushing ribs of the wedge are positioned closer to the axis of the wedge than the ribs splitting a log.

12. A wood splitting wedge according to claims 1-8, wherein inclination β of upper portions of splitting ribs is 5°-45° with respect to the axis of the wedge.

13. A wood splitting wedge according to claims 1-8, wherein inclination α of the lower portions of the twice-inclined splitting ribs compatible with the ribs of the lower regular tetrahedral pyramid positioned at the lower end extremity of the wedge is 4°-25°.

14. A wood splitting wedge according to claims 8-10, wherein notched ribs pushing the split log are designed with the greater 3° . . . 5° tilt with respect to the axis of the wedge, than the said upper portions of the twice-inclined splitting ribs.
